(19) United States
(12) Patent Application Publication
(10) Pub. No.: US 2007/0168491 A1
(43) Pub. Date: Jul. 19, 2007

(54) Method for establishing mutual talking feature on webpage

(76) Inventors: Jun-Wen Li, Taichung City (TW); Alice Li, Taichung City (TW)

Correspondence Address: CHARLES E. BAXLEY, ESQ., 90 JOHN STREET, THIRD FLOOR, NEW YORK, NY, 10038, US

(21) Appl. No.: 11/647,105

(22) Filed: Dec. 27, 2006

(30) Foreign Application Priority Data
Jan. 17, 2006 (TW) 095101784

(51) Int. Cl. G06F 15/173

(52) U.S. Cl. 709/223

(57) ABSTRACT

A method for establishing mutual talking feature on webpage includes a step of entering, a step of establishing a communication and a step of talking. The user enters a webpage having an icon and clicks the icon to activate a communication software so as to establish a line between the user and a remote end user such as the customer service people. The user and the remote end user can mutually talk via the line by using an ear set and a microphone.

### FIELD OF THE INVENTION

The present invention relates to a method for establishing a mutual instant talking feature between two users via internet webpage.

### BACKGROUND OF THE INVENTION

A known way to surf the internet websites is to click the icons on the webpage and a format made by editable software is then provided so that the user can communicate with other people by sending email via the editable software. However, this conventional way cannot obtain quick response because the one who receives the email has to do the same process as the sender and send the response by way of email. A latest development using Voice Over IP (VOIP) technique is made to use the internet to have a live talk feature and this known as internet telephone. This feature requires each user to register on the internet telephone website, so that a user who does not register the function, he or she cannot use the internet telephone to talk to the customer service people of that website.

The present invention intends to provide a method to have an instant and live talk feature by clicking icons on the webpage so that the user can talk to the customer service people of that website.

### SUMMARY OF THE INVENTION

The present invention relates to a method for establishing mutual talking feature on webpage, and the method comprises a step of entering, a step of establishing a communication and a step of talking. The user first enters a webpage that has an icon which is then clicked by the user to activate a communication software to establish a line between the user and a remote end user. The user and the remote end user then can mutually talk via the line.

The primary object of the present invention is to provide a method which allows the user to talk with the customer service people by entering a webpage and clicking an icon on the webpage or on the browser.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the steps of the first embodiment of the method of the present invention;

FIG. 2 shows the steps of the second embodiment of the method of the present invention, and

FIG. 3 shows the steps of the third embodiment of the method of the present invention.

### DETAILED DESCRIPTION OF THE PREFERRED EMBODIMENT

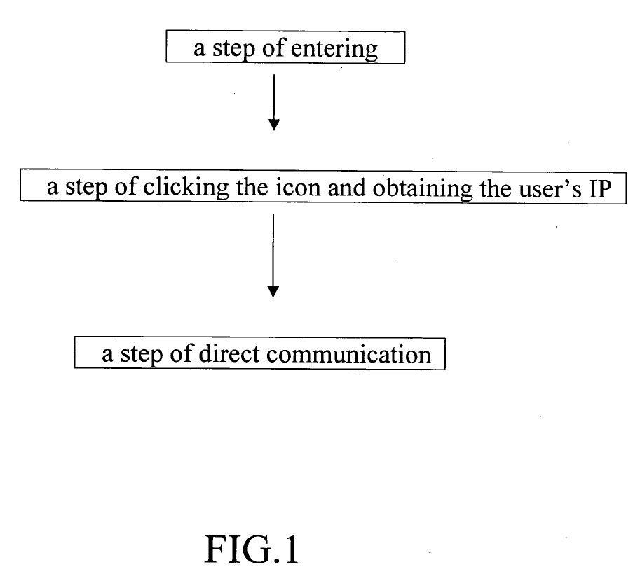

Referring to FIG. 1, the method for establishing mutual talking feature on a webpage of the present invention comprises three steps:

a step of entering, wherein a user enters a webpage by the internet protocol and browser and the webpage has an icon.

a step of establishing a communication, wherein the user activates a communication software which is installed in the webpage by clicking the icon on the webpage. The communication software obtains the user's IP or the IP of the remote end user such as the customer service people. In other words, a line is established between the user and the remote end user.

a step of talking, wherein the user and the remote end user can mutually talk via the line by internet telephone technique. The user and the remote end user can use a voice receiving device such as an ear set and a voice sending device such as a microphone.

The method of the present invention allows the user not have to install specific software when establishing the communication line with the customer service people. The user's IP and the IP of the customer service people can be automatically obtained by the software that is installed in the webpage. Therefore, when the user needs to talk to the customer service people of the webpage, he or she simply clicks the icon and talk to the customer service people.

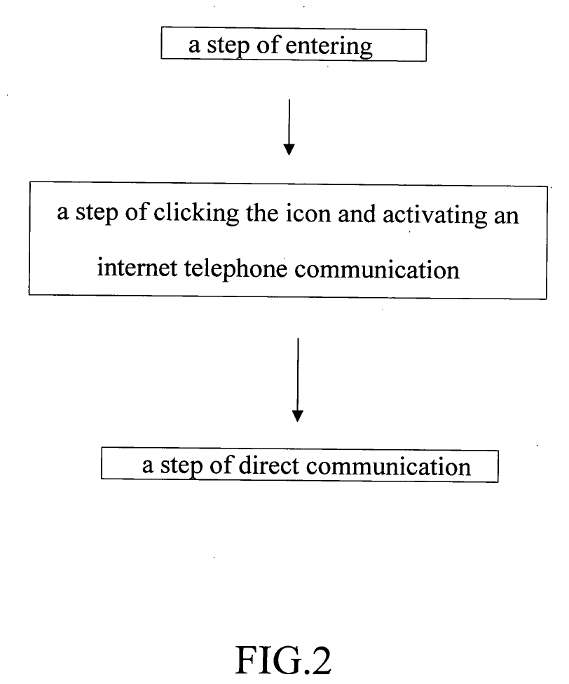

FIG. 2 shows a second embodiment of the method of the present invention, wherein the user enters the webpage in a registered member status which means that the user has to use specific user name and enter password to successfully enter the website. When entering, the website may record the user's IP. The user then activates an internet telephone communication software which is installed in the webpage by clicking the icon on the webpage. The communication software obtains the user's IP or the IP of the remote end user such as the customer service people. In other words, a line is established between the user and the remote end user. After the line is established, the user and the remote end user can mutually talk via the line by internet telephone technique. The user and the remote end user can use a voice receiving device such as an ear set and a voice sending device such as a microphone.

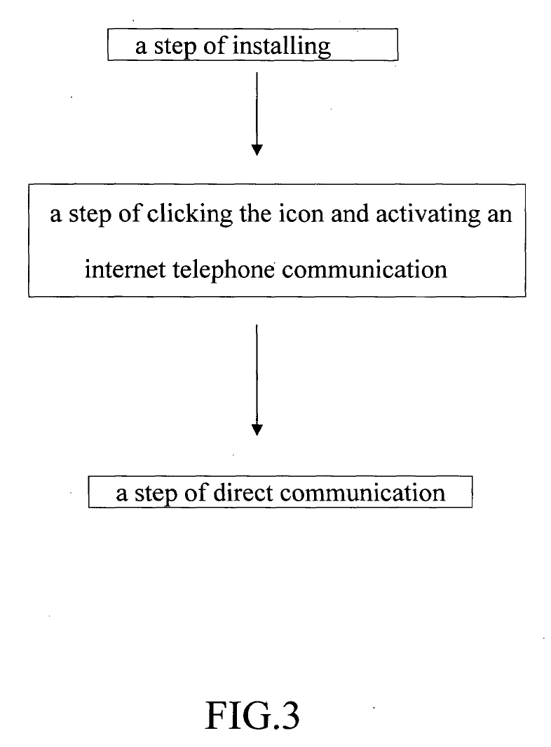

FIG. 3 shows the steps of the third embodiment of the method of the present invention. The method includes the following three steps:

a step of installing, wherein a communication software such as the internet telephone software is installed to a computer and an corresponding icon is on the webpage. The communication software is executed by connection with a browser or by executing the communication software.

a step of establishing a communication: activating a communication software by clicking the icon of the webpage or by directly the icon of the browser to establish a line between a user and a remote end user.

a step of talking: the user and the remote end user mutually talking via the line. The user and the remote end user can talk to each other by using a voice sending device and a voice receiving device.

The method of the present invention provides a simple way to directly click an icon on the webpage or of the browser to activate the internet telephone software so that the user can directly talk to the customer service people.

While we have shown and described the embodiment in accordance with the present invention, it should be clear to those skilled in the art that further embodiments may be made without departing from the scope of the present invention.

What is claimed is:

1. A method for establishing mutual talking feature on webpage, comprising:
a step of entering: a user entering a webpage and the webpage having an icon;
a step of establishing a communication: activating a communication software by clicking the icon on the webpage to establish a line between the user and a remote end user, and
a step of talking: the user and the remote end user mutually talking via the line.

2. The method as claimed in claim 1, wherein the user's IP is obtained in the step of establishing a communication.

3. The method as claimed in claim 1, wherein the step of entering includes that the user browses the webpage.

4. The method as claimed in claim 1, wherein the step of entering includes that the user enters the webpage in a registered member status.

5. The method as claimed in claim 1, wherein the step of talking is proceeded by using a voice sending device and a voice receiving device.

6. A method for establishing mutual talking feature on webpage, comprising:
a step of installing: installing a communication software to a computer and executing the communication software by connection with a browser or by executing the communication software;
a step of establishing a communication: activating a communication software by clicking an icon of the browser to establish a line between a user and a remote end user, and
a step of talking: the user and the remote end user mutually talking via the line.

7. The method as claimed in claim 6, wherein the step of talking is proceeded by using a voice sending device and a voice receiving device.
